(19) United States
(12) Patent Application Publication
(10) Pub. No.: US 2018/0236818 A1
(43) Pub. Date: Aug. 23, 2018

(54) TIRE

(71) Applicant: Sumitomo Rubber Industries, Ltd., Kobe-shi (JP)

(72) Inventor: Yuichi ISHIGAKI, Kobe-shi (JP)

(73) Assignee: Sumitomo Rubber Industries, Ltd., Kobe-shi (JP)

(21) Appl. No.: 15/881,974

(22) Filed: Jan. 29, 2018

(30) Foreign Application Priority Data
Feb. 20, 2017 (JP) 2017-029246

(51) Int. Cl. B60C 11/03; B60C 11/12

(52) U.S. Cl. CPC B60C 11/0309; B60C 11/1236; B60C 2011/1209; B60C 2011/1213; B60C 11/1204

(57) ABSTRACT

A tire includes a tread portion provided with a plurality of blocks sectioned by grooves. The plurality of blocks includes at least one reinforced block. The at least one reinforcing block includes a main body with a ground contact surface and at least one base reinforcing portion. The at least one reinforcing portion protrudes from a radially inner base portion of the main body locally toward one of the grooves without completely closing the one of the grooves, and has an amount of protruding from the main body increasing gradually inwardly in a tire radial direction.

### BACKGROUND ART

### Field of the Invention

The present invention relates to tires, and more particularly to a tire having a tread portion with a plurality of blocks.

### Description of the Related Art

In order to exhibit better steering stability on snow and wet driving conditions, tires which includes a plurality of tread blocks sectioned by grooves has been proposed, for example.

Unfortunately, when the tires as such come into contact with the ground, the tread blocks tend to deform largely, leading to wear problems comparatively quickly.

### SUMMARY OF THE INVENTION

The present invention has been made in view of the above circumstances and has an object to provide tires capable of improving wear resistance of the tread portion while maintaining driving performance on snow condition and drainage performance by modifying shapes of tread blocks.

In one aspect of the invention, a tire includes a tread portion provided with a plurality of blocks sectioned by grooves. The plurality of blocks includes at least one reinforced block. The at least one reinforcing block includes a main body with a ground contact surface and at least one base reinforcing portion. The at least one reinforcing portion protrudes from a radially inner base portion of the main body locally toward one of the grooves without completely closing the one of the grooves, and has an amount of protruding from the main body increasing gradually inwardly in a tire radial direction.

In another aspect of the invention, the base reinforcing portion may have a triangle shape in a cross-sectional view in a direction perpendicular to a longitudinal direction of the one of the grooves.

In another aspect of the invention, the at least one reinforced block may include a plurality of said base reinforcing portions.

In another aspect of the invention, the grooves may include lateral grooves, the main body of the at least one reinforced block may include at least one lateral sidewall facing at least one of the lateral grooves, and the at least one base reinforcing portion may be provided on the at least one lateral sidewall, and may has a length shorter than a length of the at least one lateral sidewall in a longitudinal direction of the lateral grooves.

In another aspect of the invention, the at least one base reinforcing portion, in the longitudinal direction, may be located in a middle region of the at least one lateral sidewall.

In another aspect of the invention, the at least one base reinforcing portion, in the longitudinal direction, may be located in an end region of the at least one lateral sidewall.

In another aspect of the invention, the at least one base reinforcing portion, in the longitudinal direction, may be located in each of an end region of the at least one lateral sidewall.

In another aspect of the invention, the at least one reinforced block, as the at least one lateral sidewall, may include a first lateral sidewall and a second lateral sidewall, the first lateral sidewall may be provided with said base reinforcing portion in each of end regions thereof in the longitudinal direction, and the second lateral sidewall may be provided with said base reinforcing portion in a middle region thereof in the longitudinal direction.

In another aspect of the invention, the plurality of blocks may include a plurality of said reinforced blocks arranged in such a manner that a plurality of base reinforcing portions appears in a zigzag manner in at least one of the lateral grooves.

In another aspect of the invention, the grooves may include main grooves extending in a tire circumferential direction, the main body of the at least one reinforced block may include at least one circumferential sidewall facing at least one of the main grooves, and the at least one base reinforcing portion may be provided on the at least one circumferential sidewall and may have a length shorter than a length of the at least one circumferential sidewall in a longitudinal direction of the main grooves.

In another aspect of the invention, the plurality of blocks may include a plurality of said reinforced blocks arranged in such a manner that a plurality of base reinforcing portions appears in a zigzag manner in at least one of the main grooves.

### BRIEF DESCRIPTION OF THE DRAWINGS

FIG. 1 is a development view of a tread portion of a tire according to an embodiment of the present invention.

FIG. 2 is a perspective view of an embodiment of a reinforced block.

FIG. 3 is a cross-sectional view taken along the line A-A of FIG. 1.

FIG. 4 is an enlarged view of some reinforced blocks of FIG. 1.

FIG. 5 is a development view of the tread portion.

FIG. 6 is a development view of a tread portion of a reference example.

### DESCRIPTION OF THE PREFERRED EMBODIMENTS

An embodiment of the present invention will be explained below with reference to the accompanying drawings.

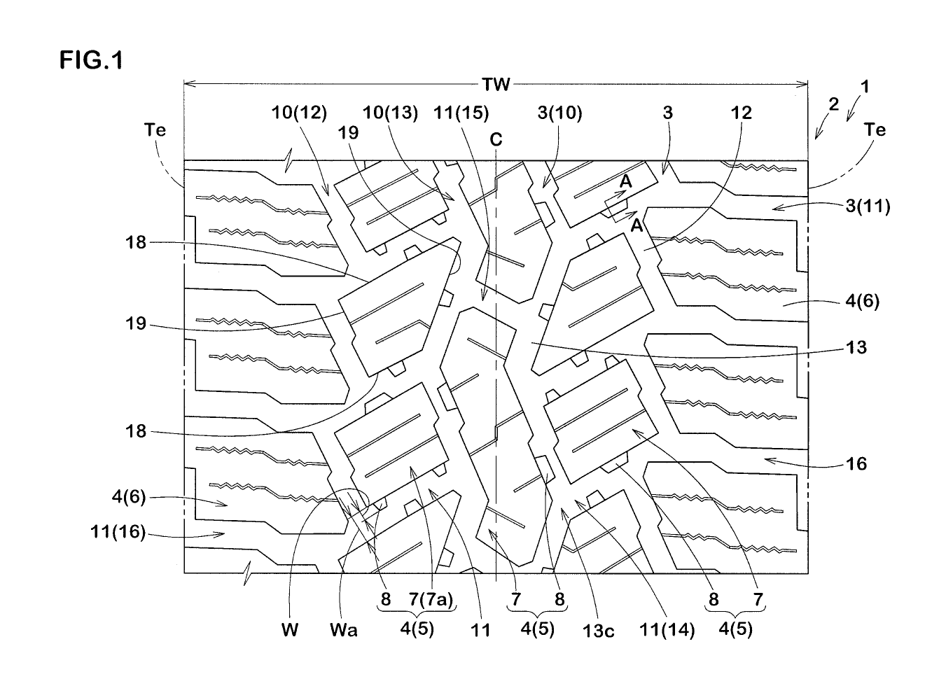

FIG. 1 illustrates a development view of a tread portion 2 of a tire 1 according to an embodiment of the present invention. As for a preferred embodiment, a pneumatic tire for passenger car is illustrated. Note that the present invention is not limited to such an embodiment, but can be embodied as heavy-duty vehicle tires and the tires belonging to the other categories, for example.

As illustrated in FIG. 1, the tread portion 2 in accordance with the embodiment is provided with a plurality of blocks 4 sectioned by grooves 3.

In this embodiment, the grooves 3 include at least one circumferentially extending main groove 10 and a plurality of lateral grooves 11 extending in the tire axial direction. The at least one main groove 10 in accordance with the present embodiment extends continuously in a zigzag manner in the tire circumferential direction. The at least one main groove 10, in this embodiment, includes a pair of shoulder main grooves 12 each arranged proximate to each tread edge Te on each side of the tire equator C and a pair of crown main grooves 13 each arranged between one of the shoulder main grooves 12 and the tire equator C on each side of the tire equator C. In some preferred embodiments, the shoulder main grooves 12 may have zigzag pitches which are half of zigzag pitches of the crown main grooves 13.

As used herein, the tread edges Te refer to axially outermost edges of the ground contacting patch of the tread portion 2 which occurs under a condition where the tire being under a standard condition is grounded on a plane with a standard tire load at the camber angle of zero. In this application including specification and claims, various dimensions, positions and the like of the tire refer to those under the standard condition of the tire unless otherwise noted.

As used herein, the distance between the tread edges Te and Te in the tire axial direction is defined as the tread width TW.

As used herein, the standard condition is such that the tire is mounted on a standard wheel rim (not illustrated) with a standard pressure, but is loaded with no tire load.

As used herein, the standard wheel rim is a wheel rim officially approved for the tire by standards organizations, wherein the standard wheel rim is the “standard rim” specified in JATMA, the “Measuring Rim” in ETRTO, and the “Design Rim” in TRA or the like, for example.

As used herein, the standard pressure is a standard pressure officially approved for the tire by standards organizations, wherein the standard pressure is the “maximum air pressure” in JATMA, the “Inflation Pressure” in ETRTO, and the maximum pressure given in the “Tire Load Limits at Various Cold Inflation Pressures” table in TRA or the like, for example.

As used herein, the standard tire load is a tire load officially approved for the tire by standards organizations, wherein the standard tire load is the “maximum load capacity” in JATMA, the “Load Capacity” in ETRTO, and the maximum value given in the above-mentioned table in TRA or the like, for example.

The lateral grooves 11, in this embodiment, are inclined at angles with respect to the tire axial direction. The lateral grooves 11 may include middle lateral grooves 14, the crown lateral grooves 15 and the shoulder lateral grooves 16. The middle lateral grooves 14 connect the shoulder main grooves 12 with the crown main grooves 13. The crown lateral grooves 15 connect the pair of crown main grooves 13. The shoulder lateral grooves 16 connect the shoulder main grooves 12 with tread edges Te.

Each of the blocks 4 is sectioned by the main grooves 10 which are adjacent in the tire axial direction and the lateral grooves 11 which are adjacent in the tire circumferential direction, or sectioned by one of the tread edges Te, one of the main grooves 10 and the lateral grooves 11 which are adjacent in the tire circumferential direction. Each of the blocks 4, for example, includes at least one lateral sidewall 18 facing at least one of the lateral grooves 11 and at least one circumferential sidewall 19 facing at least one of the main grooves 10.

The blocks 4, in this embodiment, includes at least one, preferably a plurality of reinforced blocks 5. In some preferred embodiments, the blocks 4 may also include at least one plain block 6.

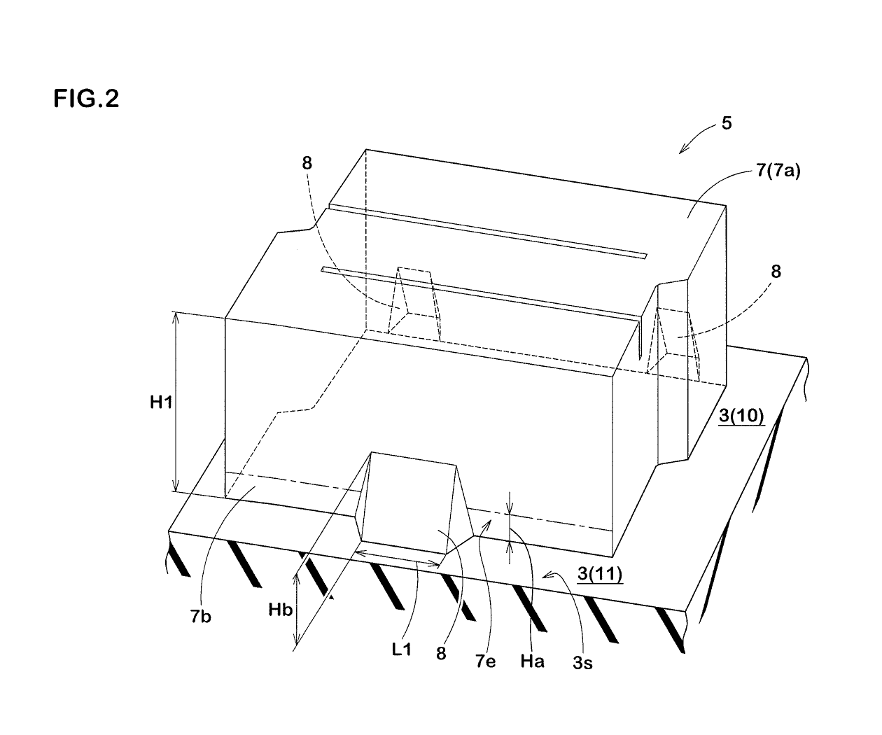

FIG. 2 illustrates a perspective view of an embodiment of the reinforced block 5. As illustrated in FIG. 2, the reinforced block 5 includes a main body 7 with a ground contact surface 7a and at least one base reinforcing portion 8 that protrudes from a radially inner base portion 7e of the main body 7 locally toward one of the grooves 3. The reinforced block 5 may improve its wear resistance since the base reinforcing portion 8 suppresses deformation of the main body 7 when traveling. In some preferred embodiments, the radially inner base portion 7e of the main body 7 may be defined as a portion having a radial height Ha equal to or less than 20% of a block height H1 of a sidewall of the main body 7 from a groove bottom 3s. In this embodiment, the base reinforcing portion 8 is arranged so as not to reach the ground contact surface 7a of the block in the tire radial direction. Note that the groove bottom 3s refers to a location or portion that has a maximum depth of the groove.

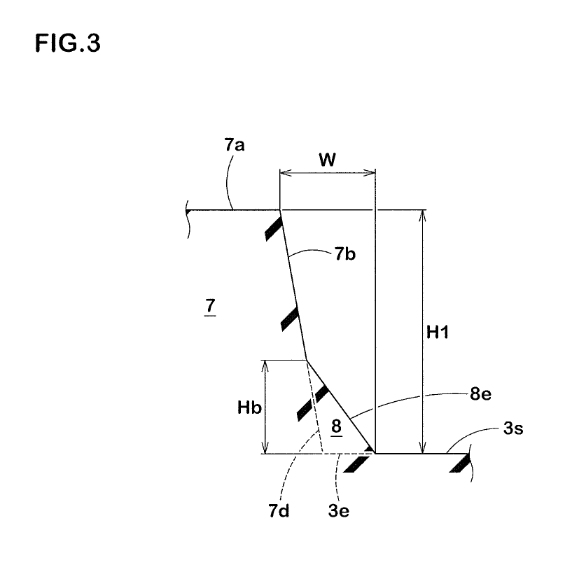

FIG. 3 illustrates a cross-sectional view of one reinforced block 5 taken long the line A-A of FIG. 1 which extends in a direction perpendicular to the longitudinal direction of the groove 3. As illustrated in FIGS. 2 and 3, the base reinforcing portion 8 has an amount of protruding from the main body 7 increasing gradually inwardly in the tire radial direction. Furthermore, the base reinforcing portion 8 is arranged without completely closing the groove 3 into which the base reinforcing portion 8 protrudes. The base reinforcing portion 8 as such may suppress the deformation of the main body 7 sufficiently, leading to further improve wear resistance. Further, the base reinforcing portion 8 may suppress reduction in volume of the groove 3, and thus may not cause deterioration in drainage performance and on-snow performance. Note that the “without completely closing” means that the base reinforcing portion 8 does not reach any other sidewalls of the blocks which are arranged adjacently through the groove 3.

In order to further improve the above advantageous effects, the base reinforcing portion 8 may have a radial height Hb from the groove bottom 3s in a range of from 40% to 60% of the block height H1. In some preferred embodiments, the base reinforcing portion 8 may have a protruding length W (illustrated in FIG. 1) from the main body 7 in a range of not more than 50%, more preferably not more than 40% of the width Wa of the groove into which the base reinforcing portion 8 protrudes, in order to further improve wear resistance while maintaining drainage performance and on-snow performance. Further, the protruding length W of the base reinforcing portion 8 may preferably be in a range of not less than 20%, more preferably not less than 30% of the width Wa of the groove 3. As used herein, the protruding length W of the base reinforcing portion 8, in the development view of the tread portion 2, is a minimum distance between the ground contact surface 7a of the main body 7 and a maximum protruding tip end of the base reinforcing portion 8, as illustrated in FIG. 3.

In some preferred embodiments, the base reinforcing portion 8, for example, has a width L1 gradually decreasing toward the tip end of the base reinforcing portion 8 in order to further improve the above effects. The width L1 of the base reinforcing portion 8 is measured along the longitudinal direction of the groove 3 into which the base reinforcing portion 8 protrudes.

In some preferred embodiments, the base reinforcing portion 8, in the development view of the tread portion 2, may be shaped in a substantially trapezoidal manner that includes two sides (bases) in parallel with the longitudinal direction of the groove 3. Note that the base reinforcing portion 8 is not limited to such a trapezoidal shape, but can be shaped in a substantially triangle and rectangle manner, for example.

As illustrated in FIG. 3, the base reinforcing portion 8, in the cross-sectional view, may have a triangle shape so as to increase the main body 7 in rigidity while suppressing volume reduction in the grooves 3. Note that the “shape of the base reinforcing portion 8 in the cross-sectional view” is defined as a cross-sectional shape which is surrounded by an outer surface 8e of the base reinforcing portion 8, a virtual extended line 3e of the groove bottom 3s and a virtual extended line 7d of the sidewall 7b of the main body 7. As used herein, the “triangle shape” includes not only a triangle shape formed by three straight lines in the strict sense but also a substantially triangle shape, e.g., curvelinear triangle with one or more arc lines.

Although the reinforced block 5 is enough to have at least one base reinforcing portion 8, the reinforced block 5, as illustrated in FIG. 2, may preferably have a plurality of base reinforcing portions 8 to further improve wear resistance thereof.

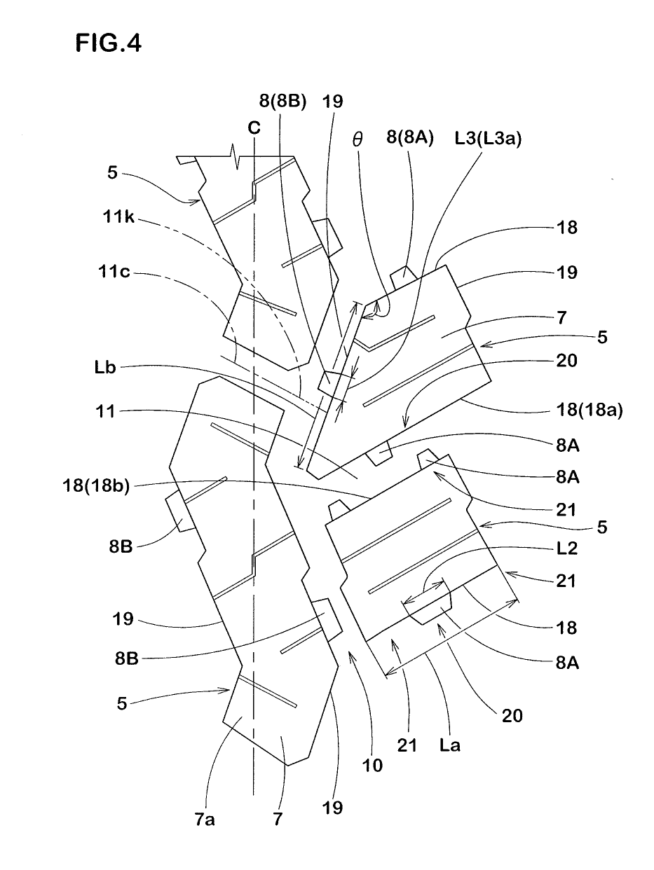

FIG. 4 illustrates an enlarged plan view of some reinforced blocks 5. As illustrated in FIG. 4, the base reinforcing portions 8 include lateral base reinforcing portions 8A provided on lateral sidewalls 18 and circumferential base reinforcing portions 8B provided on circumferential sidewalls 19. The lateral base reinforcing portions 8A may suppress effectively deformation of the main bodies 7 in the tire circumferential direction when straight traveling ahead. The circumferential base reinforcing portions 8B also may suppress effectively deformation of the main bodies in the tire axial direction when cornering.

With respect to the longitudinal direction of the lateral grooves 11, lengths L2 of the lateral base reinforcing portions 8A are preferably smaller than lengths La of the lateral side walls 18. When the lengths L2 of the lateral base reinforcing portions 8A are equal to or more than the lengths La of the lateral sidewalls 18, the volume of the lateral grooves 11 becomes insufficient. Preferably, the lengths L2 of the lateral base reinforcing portions 8A are equal to or less than 35% of the lengths La of the lateral sidewalls 18. When the lengths L2 of the lateral base reinforcing portions 8A are too small, they may not reinforce the main bodies 7 in rigidity. Preferably, the lengths L2 of the lateral base reinforcing portions 8A are equal to or more than 8% of the lengths La of the lateral sidewalls 18.

In some preferred embodiments, the lateral base reinforcing portions 8A may be located in middle regions 20 of the lateral sidewalls 18 in the longitudinal direction of the lateral grooves 11. Alternatively, in some preferred embodiments, the lateral base reinforcing portions 8A may be located in at least one end region 21 of the lateral sidewalls 18 in the longitudinal direction of the lateral grooves 11. These aspects also lead to increase the reinforced blocks 5 in rigidity effectively while suppressing groove volume reduction. Furthermore, in some preferred embodiments, the lateral base reinforcing portions 8A may be located in both end regions 21 of the lateral sidewalls 18 in the longitudinal direction of the lateral grooves 11.

As used herein, the “middle regions 20” of the sidewalls 18 mean centered regions of the sidewalls 18 with lengths of 30% of the lengths La of the sidewalls 18, and the “end regions 21” mean outside regions of the middle regions 20, i.e. with lengths of 35% of the lengths La of the sidewalls 18. Note that the region 20 or 21 to which each of the base reinforcing portions 8A and 8B belongs is decided using an area center of each of the base reinforcing portions 8A and 8B in the development view of the tread portion 2.

In this embodiment, in a pair of the reinforced blocks 5 arranged adjacently in the tire circumferential direction, a first lateral sidewall 18a faces a second lateral sidewall 18b through one lateral groove 11. On the first lateral sidewall 18a, one lateral base reinforcing portion 8A is arranged in the middle region 20. On the second lateral sidewall 18b, a pair of lateral base reinforcing portions 8A is arranged such that each lateral base reinforcing portion 8A is located in each end region 21. This aspect leads to generate large snow shearing force since a stiff compressed snow column can be formed in the lateral groove 11 on snow driving condition. In order to further improve the above effects, at least three base reinforcing portions 8, as a total number of the base reinforcing portions 8A and 8B, may preferably be provided on the first and second lateral sidewalls 18a and 18b.

In some preferred embodiments, a plurality of reinforced blocks 5 is arranged in such a manner that a plurality of base reinforcing portions 8 appears in a zigzag manner in the lateral groove 11 between the reinforced blocks 5 in order to further improve the snow shearing force. That is, the lateral base reinforcing portion 8A provided on the first lateral sidewall 18a and the lateral base reinforcing portions 8A provided on the second lateral sidewall 18b appear in turn in the longitudinal direction of the lateral groove 11.

In some preferred embodiments, at least one reinforced block 5 may have a pair of lateral sidewalls 18 each of which is provided with at least one lateral base reinforcing portion 8A. This aspect may suppress circumferential deformation of the main body 7 sufficiently when traveling. In some preferred embodiments, at least one lateral base reinforcing portion 8A may be located in the middle region 20 of at least one lateral sidewall 18. Alternatively, the at least one lateral base reinforcing portion 8A, for example, may be located in the middle regions 20 of both lateral sidewalls 18.

In some preferred embodiments, the lateral sidewalls 18 on which at least one lateral base reinforcing portion 8A is arranged are configured as a substantially single plane that extends between circumferential sidewalls 19 and 19. This aspect may be advantageous to drainage performance since less drainage resistance can be maintained when compared to zigzag lateral sidewalls.

With respect to the main groove 10 as illustrated in FIG. 4, the lengths L3 of the circumferential base reinforcing portions 8B are preferably smaller than the lengths Lb of the circumferential sidewalls 19. When the lengths L3 of the circumferential base reinforcing portions 8B are equal to or more than the lengths Lb of the circumferential sidewalls 19, volume of the main groove 10 may become insufficient.

In some preferred embodiments, a plurality of reinforced blocks 5 is arranged in such a manner that a plurality of circumferential base reinforcing portions 8B appears in a zigzag manner in the main groove 10. That is, the circumferential base reinforcing portions 8B arranged on the circumferential sidewalls 19 which face each other are alternately appear in the longitudinal direction of the main groove 10. This aspect may improve drainage performance as well as on-snow performance since the main groove 10 does not have a topical volume reduction area.

In some preferred embodiments, at least one circumferential sidewall 19 with at least one circumferential base reinforcing portion 8B, for example, may be configured as a single plane that extends between lateral sidewalls 18. This aspect may be advantageous to drainage performance since less drainage resistance can be maintained when compared to zigzag circumferential sidewalls.

Preferably, the circumferential base reinforcing portions 8B, for example, may be arranged in locations away from the locations to which extension lines 11k of the centerlines 11c of the lateral grooves 11 connected to the main groove 10, i.e., the extension lines 11k do not intersect with any outer surface 8e of the base reinforcing portions 8. Thus, the water in the lateral grooves 11 can be drained smoothly into the main groove 10.

When an angle θ of a block corner formed between one circumferential sidewall 19 with at least one circumferential base reinforcing portion 8B and one lateral sidewall 18 becomes large, the force acting on the lateral sidewall 18 affects the circumferential sidewall 19 as well. Thus, the main body 7 on the side of the circumferential sidewall 19 may be deformed by the force acting on the lateral sidewall 18. In order to suppress deformation as described above, when the angle θ of the block corner is equal to or more than 130 degrees, at least one circumferential base reinforcing portion 8B may preferably be provided on the circumferential sidewall 19.

It is needless to say, at least one lateral base reinforcing portion 8A and/or at least one circumferential base reinforcing portion 8B may be arranged on any sidewalls 7b of the main bodies 7 of the blocks.

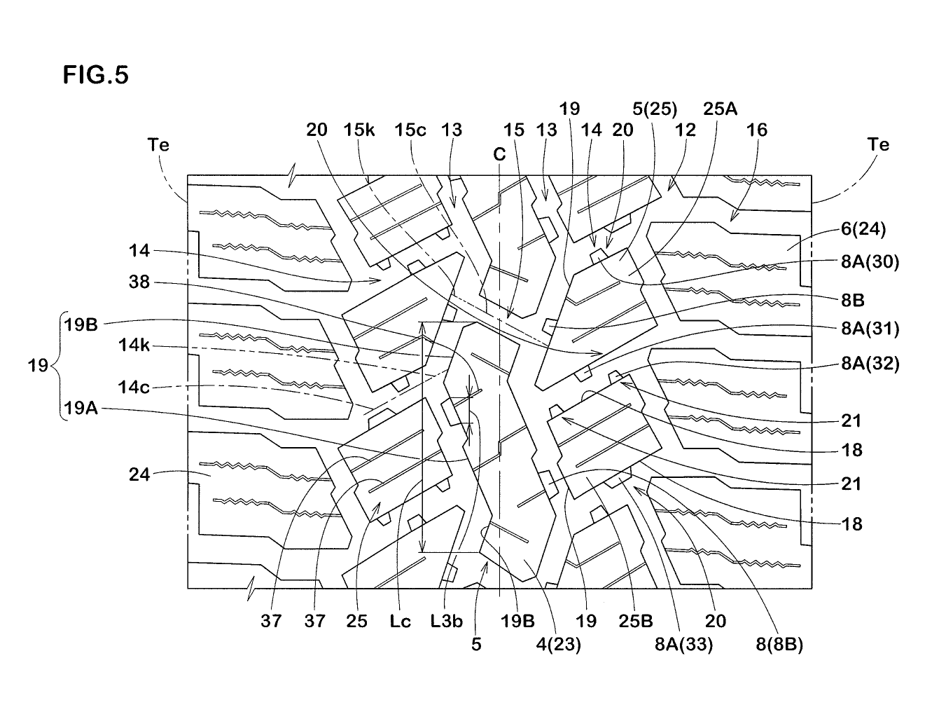

As illustrated in FIG. 5, in some preferred embodiments, the blocks 4 includes crown blocks 23, shoulder blocks 24 and middle blocks 25. The crown block 23 are arranged on the tire equator C. The shoulder blocks 24 are arranged along and proximate to the tread edges Te. The middle blocks 25 are arranged between the shoulder blocks 24 and the crown block 23.

In some preferred embodiments, the crown blocks 23 and the middle blocks 25 are configured as the reinforced blocks 5. Thus, wear resistance of the crown block 23 and the middle blocks 25 can be improved since deformation of these blocks, which receive a large ground contact pressure when straight traveling ahead, are suppressed. The shoulder blocks 24 may be configured as plain blocks 6 that are not provided with any base reinforcing portions.

The middle blocks 25, in this embodiment, are sectioned by the crown main grooves 13, the shoulder main grooves 12 and the middle lateral grooves 14, and are arranged in the tire circumferential direction. The crown block 23, in this embodiment, are sectioned by the pair of crown main grooves 13 and the crown lateral grooves 15, and are arranged in the tire circumferential direction. The shoulder blocks 24, in this embodiment, are sectioned by the shoulder main grooves 12, the tread edges Te and the shoulder lateral grooves 16, and are arranged in the tire circumferential direction.

In this embodiment, the middle blocks 25 are provided with at least one lateral base reinforcing portion 8A on every lateral sidewall 18. This aspect may be helpful to improve wear resistance of the middle blocks 25 which receive large ground contact pressure when straight traveling ahead.

The middle blocks 25, in this embodiment, include first middle blocks 25A and second middle blocks 25B. The first middle blocks 25 have circumferential sidewalls 19 with straight top edges extending between adjacent lateral grooves 11 on the side of the tire equator C. The second middle blocks 25B have the circumferential sidewalls 19 with zigzag top edges on the side of the tire equator C. The circumferential sidewalls 19 on the side of the tread edges Te of the first middle blocks 25A and the second middle blocks 25B have top edges extending in a zigzag manner.

In each of the first middle blocks 25A, on both lateral sidewalls 18 in the tire circumferential direction, one first middle lateral base reinforcing portion 30 or 31 is provided in the middle region 20 as the lateral base reinforcing portion 8A.

In each of the second middle blocks 25B, on one lateral sidewall 18 in the tire circumferential direction, one second middle lateral base reinforcing portion 32 is provided in each end region 21, and on the other lateral sidewall 18, one second middle lateral base reinforcing portion 33 is provided in the middle region 20 of the lateral sidewall 18, as the lateral base reinforcing portion 8A.

In some preferred embodiments, the first middle blocks 25A and the second middle blocks 25B are arranged such that the first middle lateral base reinforcing portion 31 and the second middle lateral base reinforcing portion 32 appear in a zigzag manner, i.e., in turn in the longitudinal direction of some lateral grooves.

The first middle blocks 25A are provided with circumferential base reinforcing portions 8B on the circumferential sidewall 19 on the side of the tire equator C. The second middle blocks 25B are nor provided with any circumferential base reinforcing portions on the circumferential sidewalls 19 on the tire equator C.

In order to improve wear resistance while maintaining on-snow performance and drainage performance, lengths L3a (illustrated in FIG. 4) of the circumferential base reinforcing portions 8B of the middle blocks 25 are preferably equal to or less than 35%, and preferably equal to or more than 8% of the lengths Lb of the circumferential sidewall 19.

In each of the middle blocks 25, the circumferential base reinforcing portions 8B, in this embodiment, are provided on the locations so as not to intersect with virtual extension lines 15k of the groove centerlines 15c of the crown lateral grooves 15.

In some preferred embodiments, the middle blocks 25 may be provided with sipes 37 having narrow widths, e.g., equal to or less than 1 mm, for example.

Preferably, the sipes 37 are inclined with respect to the tire axial direction in the same direction as the lateral sidewalls 18 with the lateral base reinforcing portions 8A. The sipes 37 as such may scratch the ground so that a water film existing under the ground contact surfaces 25a of the middle blocks 25 is removed. Further, opening of the sipes 37 may be suppressed effectively, leading to improve drainage performance and wear resistance of the tire. In view of the above, the sipes 37 preferably extend in parallel with the lateral sidewall 18 to which the sipes are located nearest.

In some preferred embodiments, the crown blocks 23 include circumferential sidewalls 19 each of which includes a first portion 19A and a pair of second portions 19B each having a shorter circumferential length than that of the first portion 19A and arranged both sides of the first portion 19A in the tire circumferential direction. The second portions 19B are inclined in an opposite direction to the first portion 19A with respect to the tire axial direction.

In some preferred embodiments of the crown blocks 23, the base reinforcing portions 8 are provided on the circumferential sidewalls 19, and are not provided on the lateral sidewalls 18. This aspect may improve the crown block 23 in lateral rigidity. Further, since the water in the crown lateral grooves 15 may be drained smoothly toward the crown main grooves 13, wear resistance and drainage performance can be improved in a good balance. The circumferential base reinforcing portion 8B, in this embodiment, is provided on the first portions 19A.

In order to further improve wear resistance while maintaining on-snow performance and drainage performance, lengths L3b of the circumferential base reinforcing portion 8B of the crown blocks 23 are preferably in a range of from 10% to 20% of the lengths Lc of the circumferential sidewalls 19. When the circumferential sidewalls 19 extend in a zigzag manner, each of the lengths L3b and Lc is defined as its circumferential length.

In some preferred embodiments, the crown blocks 23 and the middle blocks 25, which are both reinforced blocks, are arranged in such a manner that a plurality of base reinforcing portions 8B appears in a zigzag manner in the crown main grooves 13. That is, the circumferential base reinforcing portions 8B of the crown blocks 23 and the circumferential base reinforcing portion 8B of the middle blocks 25 are arranged alternately in the longitudinal direction of the crown main grooves 13. This aspect may improve drainage performance as well as on-snow performance since the crown main grooves 13 do not have a topical volume reduction area.

In some preferred embodiments, the circumferential base reinforcing portions 8B, for example, may be arranged in locations away from the locations to which an extension lines 14k of the centerlines 14c of the middle lateral grooves 14 connected to the crown main groove 13, i.e., the extension lines 14k do not intersect with any outer surfaces 8e of the circumferential base reinforcing portions 8B.

The crown blocks 23 may be provided with sipes 38. In some preferred embodiments, the sipes 38, on the development view of the tread portion 2, are in communication with the circumferential base reinforcing portions 8B. The sipes 38 as such may deliver better wear resistance since an excessive opening of the sipes can be suppressed by the circumferential base reinforcing portions 8B.

The sipes 38, for example, are preferably configured as a semi-opened sipe so as to have one end in communication with the crown main grooves 13 at one circumferential base reinforcing portion 8B and the other end terminating within the crown block 23 without reaching the tire equator C.

While the particularly preferable embodiments in accordance with the present invention have been described in detail, the present invention is not limited to the illustrated embodiments, but can be modified and carried out in various aspects.

### Example

Tires 265/70R17 having the basic tread pattern as illustrated in FIG. 1 were manufactured based on the details shown in Table 1, and then on-snow performance, drainage performance and wear resistance were tested. The common specification and test procedures are as follows.

Crown block height: 11.0 mm

Middle block height: 11.0 mm

### On-Snow Performance Test:

A test driver drove a four-wheel drive vehicle having a displacement of 3,600 cc equipped with the test tires using rims of 7.5 inches and internal pressure of 220 kPa on snow test course to evaluate the traveling performance regarding traction and steering responsive based on his sense. The test results are shown in Table 1 using a score wherein the Ref. 1 is set to 100. The larger the score, the better the performance is.

### Drainage Performance Test:

A braking distance from a point of speed 80 km/hr. was measured using the above test vehicle on an asphalt test road covered with a 5-mm deep water. The test results are shown in Table 1 using an index of values of reciprocal of the braking distances, wherein the Ref. 1 is set to 100. The larger the value, the better the performance is.

### Wear Resistance Test:

An amount of wear of each of the test tires was measured after the above test vehicle traveled on a dry asphalt road for a certain distance. The test results are shown in Table 1 using an index of values of reciprocal of the wear amounts, wherein the Ref. 1 is set to 100. The larger the value, the better the performance is.

Table 1 below shows the test results. As apparent from the test results, it was confirmed that the example tires had improved wear resistance while maintaining on-snow performance and drainage performance as compared with the reference example tire.

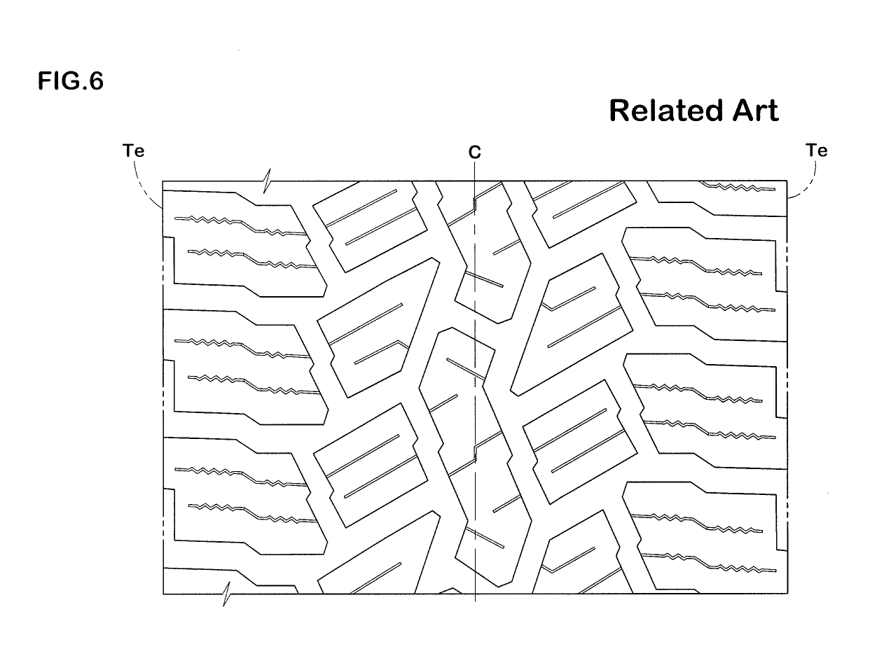

TABLE 1

| | Ref. 1 | Ex. 1 | Ex. 2 | Ex. 3 | Ex. 4 | Ex. 5 | Ex. 6 |
|---|---|---|---|---|---|---|---|
| Tread pattern | FIG. 6 | FIG. 1 | FIG. 1 | FIG. 1 | FIG. 1 | FIG. 1 | FIG. 1 |
| Cross-sectional shape of base reinforcing | — | triangle | rectangle | triangle | triangle | triangle | triangle |
| portions | | | | | | | |
| Base reinforcing portion heights Hb/H1 (%) | — | 50 | 50 | 35 | 40 | 50 | 50 |
| Base reinforcing portion lengths on middle | — | 20 | 20 | 20 | 20 | 35 | 40 |
| blocks L2/La (%) | | | | | | | |
| Base reinforcing portion lengths on crown | — | 15 | 15 | 15 | 15 | 15 | 15 |
| blocks L3b/Lc (%) | | | | | | | |
| Number of base reinforcing portions of each | — | 3 | 3 | 3 | 3 | 3 | 3 |
| middle block | | | | | | | |
| Directions of lateral sidewalls with base | — | same | same | same | same | same | same |
| reinforcing portions and sipes on middle | | | | | | | |
| blocks | | | | | | | |
| Locations of second middle base reinforcing | — | end | end | end | end | end | end |
| portions | | regions | regions | regions | regions | regions | regions |
| Layout of circumferential base reinforcing | — | zigzag | zigzag | zigzag | zigzag | zigzag | zigzag |
| portions on lateral sidewalls | | | | | | | |
| On-snow performance [score] | 100 | 98 | 96 | 98 | 98 | 96 | 96 |
| Drainage performance [index] | 100 | 98 | 96 | 100 | 98 | 98 | 96 |
| Wear resistance [index] | 100 | 115 | 116 | 110 | 113 | 116 | 117 |

| | Ex. 7 | Ex. 8 | Ex. 9 | Ex. 10 | Ex. 11 | Ex. 12 |
|---|---|---|---|---|---|---|
| Tread pattern | FIG. 1 | FIG. 1 | FIG. 1 | FIG. 1 | FIG. 1 | FIG. 1 |
| Cross-sectional shape of base reinforcing | triangle | triangle | triangle | triangle | triangle | triangle |
| portions | | | | | | |
| Base reinforcing portion heights Hb/H1 (%) | 50 | 50 | 50 | 50 | 50 | 50 |
| Base reinforcing portion lengths on middle | 20 | 20 | 20 | 20 | 20 | 20 |
| blocks L2/La (%) | | | | | | |
| Base reinforcing portion lengths on crown | 20 | 25 | 15 | 15 | 15 | 15 |
| blocks L3b/Lc (%) | | | | | | |
| Number of base reinforcing portions of each | 3 | 3 | 4 | 3 | 3 | 3 |
| middle block | | | | | | |
| Directions of lateral sidewalls with base | same | same | same | opposite | same | same |
| reinforcing portions and sipes on middle blocks | | | | | | |
| Locations of second middle base reinforcing | end | end | end | end | end region | end regions |
| portions | regions | regions | regions | regions | | |
| Layout of circumferential base reinforcing | zigzag | zigzag | zigzag | zigzag | zigzag | same |
| portions on lateral sidewalls | | | | | | circumferential |
| | | | | | | locations |
| On-snow performance [score] | 96 | 96 | 96 | 98 | 100 | 96 |
| Drainage performance [index] | 98 | 96 | 96 | 98 | 98 | 96 |
| Wear resistance [index] | 116 | 117 | 117 | 110 | 113 | 115 |

What is claimed is:

1. A tire comprising:
a tread portion provided with a plurality of blocks sectioned by grooves;
the plurality of blocks comprising at least one reinforced block;
the at least one reinforcing block comprising a main body with a ground contact surface and at least one base reinforcing portion; and
the at least one reinforcing portion protruding from a radially inner base portion of the main body locally toward one of the grooves without completely closing the one of the grooves, and having an amount of protruding from the main body increasing gradually inwardly in a tire radial direction.

2. The tire according to claim 1,
wherein the base reinforcing portion has a triangle shape in a cross-sectional view in a direction perpendicular to a longitudinal direction of the one of the grooves.

3. The tire according to claim 1,
wherein the at least one reinforced block comprises a plurality of said base reinforcing portions.

4. The tire according to claim 1, wherein
the grooves include lateral grooves,
the main body of the at least one reinforced block comprises at least one lateral sidewall facing at least one of the lateral grooves, and
the at least one base reinforcing portion is provided on the at least one lateral sidewall, and has a length shorter than a length of the at least one lateral sidewall in a longitudinal direction of the lateral grooves.

5. The tire according to claim 4,
wherein the at least one base reinforcing portion, in the longitudinal direction, is located in a middle region of the at least one lateral sidewall.

6. The tire according to claim 4,
wherein the at least one base reinforcing portion, in the longitudinal direction, is located in an end region of the at least one lateral sidewall.

7. The tire according to claim 4,
wherein the at least one base reinforcing portion, in the longitudinal direction, is located in each of an end region of the at least one lateral sidewall.

8. The tire according to claim 4, wherein
the at least one reinforced block, as the at least one lateral sidewall, comprises a first lateral sidewall and a second lateral sidewall,
the first lateral sidewall is provided with said base reinforcing portion in each of end regions thereof in the longitudinal direction, and
the second lateral sidewall is provided with said base reinforcing portion in a middle region thereof in the longitudinal direction.

9. The tire according to claim 8,
wherein the plurality of blocks comprises a plurality of said reinforced blocks arranged in such a manner that a plurality of base reinforcing portions appears in a zigzag manner in at least one of the lateral grooves.

10. The tire according to claim 1, wherein
the grooves comprise main grooves extending in a tire circumferential direction, the main body of the at least one reinforced block comprises at least one circumferential sidewall facing at least one of the main grooves, and
the at least one base reinforcing portion is provided on the at least one circumferential sidewall and has a length shorter than a length of the at least one circumferential sidewall in a longitudinal direction of the main grooves.

11. The tire according to claim 10,
wherein the plurality of blocks comprises a plurality of said reinforced blocks arranged in such a manner that a plurality of base reinforcing portions appears in a zigzag manner in at least one of the main grooves.

12. The tire according to claim 4, wherein
the grooves comprise main grooves extending in a tire circumferential direction, the main body of the at least one reinforced block comprises at least one circumferential sidewall facing at least one of the main grooves, and
the at least one base reinforcing portion is provided on the at least one circumferential sidewall and has a length shorter than a length of the at least one circumferential sidewall in a longitudinal direction of the main grooves.

13. The tire according to claim 8, wherein
the grooves comprise main grooves extending in a tire circumferential direction, the main body of the at least one reinforced block comprises at least one circumferential sidewall facing at least one of the main grooves, and
the at least one base reinforcing portion is provided on the at least one circumferential sidewall and has a length shorter than a length of the at least one circumferential sidewall in a longitudinal direction of the main grooves.

14. The tire according to claim 9, wherein
the grooves comprise main grooves extending in a tire circumferential direction,
the main body of the at least one reinforced block comprises at least one circumferential sidewall facing at least one of the main grooves, and
the at least one base reinforcing portion is provided on the at least one circumferential sidewall and has a length shorter than a length of the at least one circumferential sidewall in a longitudinal direction of the main grooves.

15. The tire according to claim 14,
wherein the plurality of blocks comprises a plurality of said reinforced blocks arranged in such a manner that a plurality of base reinforcing portions appear in a zigzag manner in at least one of the main grooves.
